(19) United States
(12) Patent Application Publication
(10) Pub. No.: US 2001/0009180 A1
(43) Pub. Date: Jul. 26, 2001

(54) COMPOSITIONS AND PROCESSES FOR INCREASING HOT STOCK SIZING EFFECTIVENESS

(75) Inventors: MALCOLM JAMES WELCH, HOEVELAKEN (NL); ANDREW MEARS, KENT (GB)

Correspondence Address: STEPHEN M. ROYLANCE, GREENBLUM & BERNSTEIN, 1941 ROLAND CLARKE PLACE, RESTON, VA, 20191

(73) Assignee: HERCULES INC.

(21) Appl. No.: 08/965,062

(22) Filed: Nov. 5, 1997

(51) Int. Cl. C08J 3/02; D21H 27/00

(52) U.S. Cl. 162/158; 162/164.1; 162/179; 162/135; 162/164.6; 106/219; 106/238; 106/218

(57) ABSTRACT

Method of processing pulp with a sizing agent, comprising adding to a cellulosic pulp, in a wet part of a paper making process, a sizing mixture of (a) rosin material and (b) an AKD sizing agent wherein at least a portion of the wet part of the paper making process is at a temperature of at least about 40° C.

1. Field of the Invention

This invention relates to paper sizing compositions, and to processes of sizing paper, as well as processes of producing sized paper from paper stock, such as paper stock comprising cellulose fibers.

2. Discussion of Background Information

Paper is made by a process that includes forming a paper making pulp or slurry, followed by forming the pulp or slurry into a membrane from which the paper sheet is eventually formed. The wet part (as this term is used herein) of the process includes all the stages in furnish preparation, including pulp blending and refining, through thick stock and thin stock blending, chemical additions and dilutions with both white water and fresh incoming water, to the point of deposition of fiber and membrane formation on the wire, at the wet end of the paper making process. Thus, the wet part of the process includes all stages of the paper making process through the formation of the sheet. As used herein, internal sizing refers to sizing associated with the addition of size at the wet part of the paper making process, and thus internal sizing or sizing at the wet part of the paper making process refers to the addition of size at any of the stages of the wet part of the process.

During the last few years, paper making, during the wet stages leading up to the wet end has changed. More and more water is recycled and some mills preferably run with closed water systems. A consequence has been a temperature increase throughout the stock and furnish wet-part preparation stages and wet end cycle of paper making, to 70° C. or greater in some mills. Frequently, this has been coupled with an increase in the pH throughout the same cycle, from, for example, pH 4-5 to pH 6-8, because, among 5 other things, of the change from clays to carbonates as components of filled paper furnishes.

Under these conditions sizes lose efficiency due to saponification (for example, rosin saponification) and hydrolysis (for example, hydrolysis of cellulose reactive size, including ketene dimers, such as alkyl ketene dimers and alkenyl ketene dimers, and multimers thereof), and alum loses effectiveness due to hydrolysis. Ketene dimers, including alkyl ketene dimers and alkenyl ketene dimers, and multimers of these materials are all collectively referred to herein as “AKD.”

The rosin size materials currently in use, will lose as much as 50% of their effectiveness or efficiency as the temperature, during the wet part of the paper making process, increases from about 40° C. to 50° C. to 55° C. The progressive continuing loss in efficiency, as temperatures rise to 70° C., and above renders rosin sizing ineffective.

In addition to the temperature factor, other aspects of some paper machines can adversely create and exaggerate conditions for unfavorable chemistry. For example, some machines lack a degree of flexibility for experimentation with consequential or concurrent additions of sizing materials, alum and other wet part paper ingredients, in order to achieve efficiency gains. The dwell time of the paper making chemicals with the fiber, from the points of addition, to the paper machine flow box, wire and press section exposes the chemicals to a hostile environment, which the compositions and processes of this invention serve to minimize.

While it is generally true that AKD is less affected, chemically, by these more aggressive conditions, deposits which contaminate the machine and the formation of non-sizing byproducts, which interfere with efficiency and sometimes with subsequent paper converting stages, will be minimized by sizing materials, that reduce the amount of vulnerable chemical at source.

Combinations of rosin size and cellulose reactive sizes (AKD's, acid anhydrides, organic isocyanates and carbamoyl chlorides) are known, such as U.S. Pat. No. 4,522,686, to DUMAS (commonly assigned to Hercules Incorporated), and U.S. Pat. No. 4,816,073 to HELMER et al., assigned Casco Nobel AB. Each of these patents is hereby incorporated by reference, as though set forth in full herein.

The process of paper making and the use of paper making chemicals is continually evolving. A descriptive analysis of recent changes in chemistry and process is given by Shelley, “Size Matters”, Chemical Engineering, pp.59-62, August 1997, which document is hereby incorporated by reference, as though set forth in full herein. However even this recent review does not describe the impact of the increase in temperature at the wet part of the paper making cycle, a phenomenon referred to colloquially as hot stock sizing. The choices available to the papermaker hitherto, for combating the loss in sizing performance, resulting from increase in temperature and pH have been to increase the addition rate of the size, cool the water, stock and fumish or slow the process down. All of these options lead to cost increases. By the application of the compositions and methods described in the present invention, efficient and cost-effective sizing results even at temperatures of 70° C., or higher.

### SUMMARY OF THE INVENTION

It has been unexpectedly discovered that mixtures of (a) rosin size and (b) ketene dimer and/or multimer have superior sizing properties as compared to either of the sizes used separately for sizing cellulosic products, including paper and board, at temperatures exceeding 40° C., preferably up to 70° C. and higher, during the wet part oI the paper making process. Thus, it has been unexpectedly found that mixtures of rosin size and ketene dimer and/or multimer are more efficient sizes for paper made under hot stock conditions, than the sizes used on their own, in similar conditions.

Suitable ketene dimers and multimers comprise AKD sizing agents comprising a member selected from the group consisting of alkyl (straight or branched) ketene dimers, alkenyl (straight or branched) ketene dimers, and multimers of alkyl ketene dimers and alkenyl ketene dimers, and mixtures of the foregoing.

Suitable AKD components comprise ketene dimers of Formula I, below:

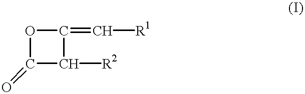

herein R¹ and R², which can be the same or different, are organic hydrophobic groups, defined in further detail below.

Suitable AKD multimers for use in the present invention include compounds of Formula (II), below:

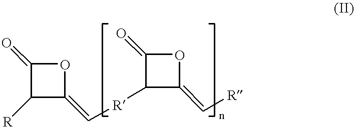

wherein n, R, R¹ and R² are as defined below.

The AKD component can include compounds of Formula I alone, compounds of Formula II alone, or mixtures of compounds of Formulae I and II.

In accordance with one aspect of the invention, the invention comprises a method of processing pulp with a sizing agent, comprising adding to a cellulosic pulp, in a wet part of a paper making process, a sizing mixture of (a) rosin material and (b) an AKD sizing agent wherein at least a portion of the wet part of the paper making process is at a temperature of at least about 40° C.

The AKD sizing agent can comprise a member selected from the group consisting of ketene dimers, ketene multimers and mixtures thereof. The AKD sizing agent can also comprise a member selected from the group consisting of alkyl ketene dimers, alkenyl ketene dimers, and multimers and mixtures thereof.

In another aspect of the invention, the invention comprise a method of processing pulp with a sizing agent, comprising:

adding to a cellulosic pulp, in a wet part of a paper making process, a sizing mixture of (a) rosin material and (b) an AKD sizing agent, the AKD sizing agent comprising at least one compound selected from compounds of the formula:

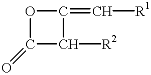

wherein R¹ and R², which can be the same or different, are organic hydrophobic groups, selected from saturated or unsaturated hydrocarbon, straight or branched chain alkyl having at least 6 C atoms, cycloalkyl having at least 6 carbon atoms, aryl, aralkyl and alkaryl,

and/or a compound of the formula:

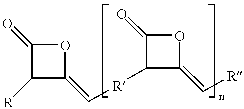

wherein

n is an integer of from 1, to about 20;

R and R″ are the same or different and are an organic hydrophobic group having at least 6 C atoms, independently selected from the group of straight (linear) or branched alkyl or straight (linear) or branched alkenyl; and

R′ is a branched or straight chain, or alicyclic, of from about 1 to about 40 carbon atoms. and mixtures of compounds of the foregoing compounds, wherein at least a portion of the wet part of the paper making process is at a temperature of at least about 40° C.

As noted above, the temperature of at least a portion of the wet part of the paper making process is at a temperature of at least about 40° C., and can be much higher, such as at least about 70° C. or higher, with temperatures at which the process can be performed including at least about 45° C., at least about 50° C., at least about 55° C., at least about 60° C., at least about 65° C. This temperature can be throughout the entire process, substantially throughout the entire process, or only a portion of the process.

Each of the foregoing processes can also preferably be conducted with sizing mixtures further comprising (c) alum.

The components (a) and (b), and optionally (c) can be added during any portion of process, e.g., any portion of the wet part.

### BRIEF DESCRIPTION OF THE DRAWINGS

The foregoing and other objects, features, and advantages of the invention will be apparent from the following more particular description of the preferred embodiment as illustrated in the accompanying drawings in which reference characters refer to the same parts throughout the various views, and wherein:

FIG. 1 is a schematic illustration of a process for making and sizing paper in accordance with the invention, carried out continuously.

### DETAILED DESCRIPTION OF PREFERRED EMDODIMENTS OF THE INVENTION

The present invention has particular application in internal sizing, i.e., sizing associated with the addition of size to the paper making process at the wet part of the paper making process.

As used herein, whenever reference is made to a compound it includes the individual compound as well as mixtures of the compound, unless otherwise excluded Thus, for example, reference to ketene dimers includes the occurrence of a single ketene dimer and mixtures of various ketene dimers.

In accordance with the present invention, it has been unexpectedly discovered that mixtures of (a) rosin and (b) ketene dimers and/or multimers are more effective at these high temperature and pH paper making conditions and that this synergy leads to more efficient sizing. The reason for this is not fully understood but it is believed that the retention of both the rosin and ketene dimer and/or multimer is beneficially improved. Without wishing to be bound by theory, it is believed that the mechanism for this is probably due to colloidal properties of the system for example charge effects leading to improved adsorption of size to the cellulose fiber and solid particle and liquid size combinations creating more efficient surface fiber adsorption and fiber pore penetration. It is known that rosin alone would be expected to be less effective as temperature of the wet portion of the process increases.

Rosin and Ketene Dimer and/or Multimer Compounds

Rosin and AKD materials suitable for application in this invention include any such material that act as sizing agents and can be utilzed in various forms, such as in aqueous dispersions and emulsions. Suitable rosin materials include tall oil rosin, wood rosin and gum rosin. The rosin component can be fortified or adducted by reaction with an α,B- unsaturated polybasic acid or anhydride. It can also be modified by mixture with rosin esters or by direct esterification with for example glycerol or pentaerythritol. Rosin anhydrides are also derivatives of rosin which are useful components in this process.

Suitable rosin materials are well known to those of ordinary skill in the paper making art. Suitable rosin materials are discussed in U.S. Pat. No. 4,522,686 to DUMAS, cited and incorporated by reference above. This patent and all documents cited therein relating to rosin materials are specifically incorporated by reference herein for their disclosures of suitable rosin components.

Suitable ketene dimers and/or multimers include saturated (branched and/or straight chain) and unsaturated (branched and/or straight chain) compounds. Preferred compounds include ketene dimers of Formula I, as described above. Preferred compounds of Formula I are those wherein R¹ and R², which can be the same or different, are organic hydrophobic groups, preferably saturated or unsaturated hydrocarbon structures such as alkyl and alkenyl (each can independently be straight or branched chain) having at least 6 C atoms, more preferably at least 8 C atoms, cycloalkyl having at least 6 carbon atoms, aryl, aralkyl and alkaryl, and preferably straight or branched alkyl and alkenyl groups of 12-30 C atoms, more preferably 16-22 C atoms, and in some embodiments, most preferably 16-18 C atoms.

Expanding on the above, in cases where R¹ and R² are both saturated, the compounds of Formula I can be termed alkyl ketene dimers. However, in cases wherein one or both of R¹ and R² contain unsaturation (by virtue of, for example, the presence of one or more double bonds) the compounds of Formula I can be termed alkenyl ketene dimers. Thus, both alkyl ketene dimers and alkenyl ketene dimers are embraced by the term AKD herein, and therefore by Formula I.

Thus, R¹, and R², which can be the same or different, can have mono or polyunsaturation, can be straight or branched chained, and have from about 1 to about 5 double bonds in the chain, preferably from about 1 to about 3 double bonds and more preferably 1 or 2 double bonds and contain the carbon atom ranges specified above.

Suitable ketene dimers for use in the present invention are disclosed in U.S. Pat. No. 4,522,686, to DUMAS and U.S. Pat. No. 4,816,073 to HELMER et al., incorporated by reference above, which patents are also incorporated by reference as though set forth in full herein for their disclosures of alkyl ketene dimers, alkenyl ketene dimers, and starting materials for making such ketene dimers.

Suitable ketene multimers, e.g., 2-oxetanone-based ketene multimers, are also well-known to those of ordinary skill in the art. Referring to Formula (II) above, suitable ketene multimers for use with the present invention are those wherein n is an integer of at least 1, preferably 1 to about 20 and more preferably about 1 to about 8, even more preferably about 1 to about 6, and even more preferably about 2 to about 5.

Mixtures of the 2-oxetanone ketene multimers preferably contain regio isomers of such multimer compounds and preferably contain an average n of from about 1 to about 6 and more preferably from about 2 to about 5. Such mixtures of 2-oxetanone ketene multimers may also contain some 2-oxetanone ketene dimer, i.e., n=0 in formula (II) (of course, as will be readily understood, when n=0, a compound in accordance with Formula (I) results), as a consequence of the preparation method (described below) used to make the multimers.

R and R″ are substantially hydrophobic in nature, are acyclic, are preferably hydrocarbons of at least about 4 carbon atoms in length, preferably at least 6, and may be the same or different. R and R″ are more preferably about C 10-C 20 and most preferably about C 14-C 16.

R and R″, which may be the same or different, are preferably independently selected from the group of straight (linear) or branched alkyl, or straight (linear) or branched alkenyl. R and R″ are more preferably linear alkenyl. Preferably not all R and R″ substituents are straight alkyl chains and preferably at least 25% by weight of the sizing agent comprises the 2-oxetanone structure in which at least one of R and R″ is not straight chain (linear) alkyl. R and R″ are ordinarily derived from a monocarboxylic acid reactant, e.g, fatty acid and preferably an unsaturated fatty acid, when the ketene multimer is prepared from reaction of a monoacid component with a diacid component, as described below.

R′ may be a branched, straight chain, i.e., linear, or alicyclic, i.e., cyclic-containing, hydrocarbon and is preferably a hydrocarbon of from about 1 to about 40 carbon atoms. R′ may more preferably be selected from about C 2-C 12 and most preferably from C 4-C 8; in such cases, R′ is preferably a straight chain akyl. Alternatively, R′ may more preferably be selected from about C 20-C 40 and most preferably from about C 28-C 32; R′ is preferably branched or alicyclic, for the more preferred about C 20-C 40 and most preferred about C 28-C 32.

R′ is ordinarily derived from a dicarboxylic acid reactant when the ketene multimer is prepared from reaction of a monoacid component with a diacid component.

Ketene dimers and multimers and emulsions thereof which can be employed in the present invention include the PRECIS sizing agents commercially available from Hercules Incorporated, and which are disclosed in co-pending U.S. Pat. Application No. 08/192.570, filed Feb. 7, 1994 (to be issued as U.S. Pat. No. 5,685,815 on Nov. 11, 1997; European family member to be published as EP 666,368 on Aug. 9, 1998), the disclosure of which is hereby incorporated by reference as though set forth in full herein. Co-pending U.S. patent application No. 08/439,057, filed May 8, 1995 (European family member published May 8, 1995), which is hereby incorporated by reference as though set forth in full herein, discloses ketene dimers and multimers usefull in the invention that are made from saturated and unsaturated fatty acids and emulsions thereof. Co-pending U.S. patent application No. 08/601,113, filed Feb. 16, 1996 (PCT/US96/12172 filed Jul. 25, 1996), which is hereby incorporated by reference as though set forth in full herein, discloses ketene multimers useful in the invention. Canadian Patent 2,117,318, laid open Dec. 11, 1994, which is hereby incorporated by reference as though set forth in full herein, discloses ketene multimers and emulsions thereof useful in the present invention.

Examples of preferred commercial AKD's include PRECIS 800 (for those compounds wherein R¹ and R² are primarily in the C16 range) (IUPAC name: 2-oxetanone, 4-(8-heptadecenylidene),3-(7-hexadecenyl) CAS number 56000-16-9) (liquid at room temperature); AQUAPEL 364 (for those compounds wherein R¹ and R² are primarily in the C16-18 range) (IUPAC name: 2-oxetanone,3-(C12-C16)alkyl,4-(C13-C17)alkylidene; CAS number 84989-41-3) (M.P. 40-47° C.); AQUAPEL 291 (for those compounds wherein R¹ and R² are primarily in the C18 range) (IUPAC name: 2-oxetenone, 3 -(C14-C16)alkyl,4-(C15-C17)alkylidene; CAS number 98246-81-8) (M.P. 60-62° C.); and AQUAPEL 532 (for those compounds wherein R¹ and R² are primarily in the C22 range) (IUPAC name: 2-oxetanone,3-eicosyl,4-heneicosylidene (CAS number 83707-14-9) (M.P. 63-64° C.).

Rosin sizes useful in the invention include dispersed rosin size stabilized by one or more cationic colloidal coacervate dispersing agents, such as ULTRAPHASE rosin sizing compositions disclosed in co-pending U.S. patent application No. 08/594,612, filed Feb. 2, 1996 (PCT/US97/01274, filed Jan. 29, 1997), the disclosure of which is hereby incorporated by reference as though set forth in full herein.

The dispersed or emulsified hydrophobic rosin or AKD component is preferably stabilized with surfactants and with surfactant colloidal polymer systems. Examples of suitable stabilizing components are casein, water-soluble, nitrogen-containing cationic polymers and dispersing agents, anionic surfactants, starch and dispersing agent mixtures.

The mixtures of size can be made by blending size dispersions before use or blending the rosin and AKD before dispersion. Suitable size dispersions (both rosin size and AKD size) can be readily formulated and prepared by those of ordinary in the art, based on the teachings of U.S. Pat. No. 4,522,686, to DUMAS and U.S. Pat. No. 4,816,073 to HELMER et al., incorporated by reference above, and U.S. Pat. No. 4,373,673 to ALDRICH (commonly assigned to Hercules Incorporated and which patent is hereby incorporated by reference as though set forth in full herein for its teachings regarding paper sizing in general) all of which patents are also incorporated by reference as though set forth in full herein for their disclosures of how to prepare such sizes. Additionally, suitable sizes can also be prepared in the accordance with the teachings of co-pending U.S. patent application No. 08/192,570, filed Feb. 7, 1994 (to be issued as U.S. Pat. No. 5,685,815 on Nov. 11, 1997); co-pending U.S. patent application No. 08/439,057, filed May 8, 1995; co-pending U.S. patent application No. 08/601,113, filed Feb. 16, 1996; and Canadian Patent 2,111,318, laid open Dec. 11, 1994, which documents are incorporated by reference above and which are hereby incorporated by reference as though set forth in full herein for their disclosures of how to prepare such sizes.

The amounts of rosin and AKD materials employed are as follows: The weight ratio of rosin to cellulose reactive product range from about 0.05:1 to about 20:1, and preferably from about 1:1 to about 10:1, more preferably from about 2:1 to about 8: 1, and preferably from about 3:1 to about 6:1.

Additionally, in preferred embodiments, alum is also employed as part of the size mixture. Suitable alums are well-known to those of ordinarv skill in the art, and include papermaker's alum, aluminum sulfate, Al₂(SO₄)₃, with various amounts of water of hydration. Other similar equivalent well-known aluminum compounds, such as aluminum chloride, aluminum chlorohydrate, polyaluminum chlorides, and mixtures thereof, may also be used.

When used, the alums are employed in amounts and under conditions well-known to those of ordinary skill in the art. Thus, the alums are preferably employed in amounts such that the ratio of amount of size to alum, by weight is from about 1:0.5 to about 1:2.5.

Sizes containing alums be readily formulated and prepared by those of ordinary in the art, based on the teachings of U.S. Pat. No. 4,522,686, and U.S. Pat. No. 4,373,673 to ALDRICH, each of which is incorporated by reference as though set forth herein for this purpose.

In preferred embodiments, the process is conducted at a pH of from about 4-9 preferably from about 5 to about 9, more preferably from about 5 to about 8 and more preferably from about 6 to about 8. The pH is adjusted by variable addition of standard acids or bases to raise or lower the pH. Typically, sulfuric acid is advantageously employed to lower pH and alkaline materials, e.g., caustic soda, sodium bicarbonate, soda ash, sodium aluminate and the like, are employed to increase pH.

Additionally, in preferred embodiments, additives are employed. Typical additives include alum used to reduce viscosity, defoamers, biocides and other preservatives, can be added to the rosin-coacervate dispersion of the present invention in amounts and using techniques known to those in the paper making industry.

The sizes are used in dispersed and emulsified form in water. They are made by emulsification and stabilization of the sizes with mixtures of surfactant and colloidal polymer. While it is possible to make a blend of rosin and reactive size and stabilize the mixture as an emulsion with a combination of surfactant and colloidal polymer, this is not the preferred method. Premixing rosin and cellulose reactive size limits to some extent the flexibility with which formulations with different blend ratios of rosin and reactive size can be made and to some extent decreases the efficiency of the reactive size component, by exposing it to higher than normal temperatures during manufacture.

The present invention is usefull in commercial paper making processes.

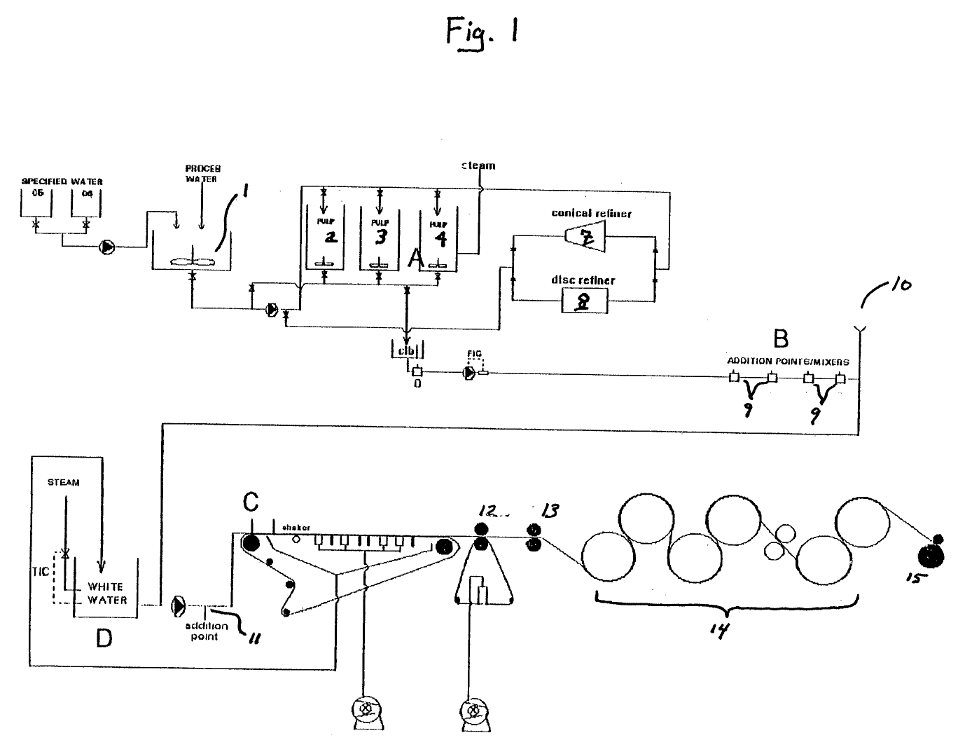

A suitable process, designed to model hot stock sizing conditions of commerical paper machines, is schematically illustrated in FIG. 1. The process of FIG. 1 includes:

1. The preparation of unrefined furnish stock in the tank 1.

2. Pulp refining is conducted in the conical refiner 7 or disc refiner 8.

3. Refined pulp stored, ready for use in the stock chests 2, 3, and 4.

4. In the examples herein, steam was injected into the stock chest 4 to the raise the temperature for each experiment. However, steam could also be added at the other steam addition points as shown in FIG. 1.

5. The paper making furnish is drawn from stock chest 4 and paper making chemicals added, at the addition points 9, funnel 10 or addition point 11.

6. Location C is the flow box, the point at which the paper making furnish flows at a controlled rate onto the fourdrinier wire.

7. The dewatering process begins at this stage, starting with pressing (wet press 12 and offset press 13).

8. Dewatering is completed by drying in the dryer section 14.

9. The paper is reeled at station 15.

The system of FIG. 1 was designed to operate on an experimental scale; however, one of ordinary skill in the art could readily scale up such a system based on teachings in the present specification and on readily available information conventionally available to one of ordinary skill in the art.

Details and optimization of routine parameters can be found, for example, in Pulp and Paper, Chemistry and Chemical Technology, Casey, James P. (editor), J. Wiley, 3d. edition (1980), the entire disclosure of which is hereby incorporated by reference, as though set forth in full herein.

Without further elaboration, it is believed that one skilled in the art can, using the preceding description, utilize the present invention to its fullest extent.

The following preferred specific embodiments are, therefore, to be construed as merely illustrative, and not limitative of the remainder of the disclosure in any way whatsoever. In the following examples, all temperatures are set forth uncorrected in degrees Celsius; unless otherwise indicated, all parts and percentages are by weight.

### EXAMPLES

Hot Stock Sizing

Sizes prepared by blending Hercules® sizes, consisting of dispersed rosin, with dispersed and emulsified AKD size, have been compared as internal sizes at paper making temperatures of between 40 and 70° C., with the same sizes used individually. Although the sizes to exemplify this invention were pre-blended from the rosin and AKD size, the addition of the sizes separately into a common addition point, e.g., at the location labelled funnel in FIG. 1 also gives the observed improvements in sizing. Paper making was continuous on a fourdrinier machine with the temperature established at each condition from the machine chest to the flow box. Size and alum were added consecutively with sufficient time for the size and alum to reach the temperature of the furnish.

Sizing was measured by Cobb test and HST (Hercules Size Test).

The Cobb test measures the water absorptiveness of sized (non bibulous) paper and paper board, in accordance with TAPPI Method T441 OM/90, revised 1990.

The HST test is a size test for paper by ink resistance, TAPPI Method T530PM/89, revised 1989. This test is also described in Pulp and Paper Chemistry and Chemical Technology, J.P. Casey, Ed., Vol.3, p. 1553-1554 (1981), which document is hereby incorporated by reference, as though set forth in full herein.

Additionally, descriptions of these tests may be obtained from TAPPI Press, Technology Park, Atlanta, PO Box 105113, GA30248-5113. The Hercules Size Test is discussed in further detail below.

The Hercules Size Test determines the degree of water sizing obtained in paper by measuring the change in reflectance of the paper's surface as an aqueous solution of dye penetrates from the opposite surface side. The aqueous dye solution, e.g, naphthol green dye in 1% formic acid in Examples 2 and 3 described below, is contained in a ring on the top surface of the paper, and the change in reflectance is measured photoelectrically from the bottom surface.

Test duration is limited by choosing a convenient end point, e.g., a reduction in reflected light of 20%, corresponding to 80% reflectance, in Examples 2 and 3 described below. A timer measures the time (in seconds) for the end point of the test to be reached. Longer times correlate with increased sizing performance, i e., resistance to water penetration increases. Unsized paper will typically fail at 0 seconds, lightly sized paper will register times of from about 1 to about 20 seconds, moderately sized paper from about 21 to about 150 seconds, and hard sized paper from about 151 to about 2,000 seconds.

This test is discussed in co-pending U.S. patent application No. 08/594,612, filed Feb. 2, 1996 (PCT/US97/01274, filed Jan. 29, 1997), the disclosure of which is hereby incorporated by reference as though set forth in full herein for its disclosure of the Hercules Size Test.

Additionally, the following procedures were employed in the experiments described in the Examples below.

The temperature was raised by steam injection to the stock chest, shown as A on FIG. 1. The steam injection was controlled to give the temperature required for each experiment and the temperature was measured at each of the locations, A, B, C and D. Position B is the addition point for the size and alum, C is the flow box and D is the white water tank. Temperatures were allowed to come to equilibrium during each experiment. There were heat losses through the process and steam injection was controlled to limit the temperature variable to + or −2 degrees centigrade from A through to D.

### Example 1

Hi-pHase 35J a rosin size made and sold by Hercules® Inc was used to size paper at various addition levels at increasing temperatures stabilized and measured at positions A, B, C and D located on FIG. 1.

The degree of sizing was measured in a paper furnish consisting of a blend of unbleached kraft (UBK) 30 parts and waste test liner 70 parts. Temperatures of 40 and 60° C. were maintained and the results are given in Table 1. Alum was added at equal parts dry basis to the size.

TABLE 1

| Dry basis | Cobb sizing, naturally aged paper (gm/sq.m./60 seconds) | |
|---|---|---|
| size level (%) | Paper made at 40° C. | Paper made at 60° C. |
| 0.5 | 26 | 30.7 |
| 0.75 | 22.4 | 24.4 |
| 1.0 | 20.4 | 21.6 |

The results of this experiment show how sizing deteriorates as temperature increases from 40 to 60 and to achieve a Cobb sizing of 22 seconds the volume of size added at 60° C. had to be increased by 33% by weight.

### Example 2

Two sizes, Hi-pHase 35J and Precis 8023 (a size formulated from the AKD Precis 800, described above), both available from Hercules UK, 31 London Rd, Reigate, Surrey, UK, RH2 9YA were blended together, as follows. Hi-pHase 35J (150.65 parts) was charged to a vessel and stirred with a paddle stirrer, Precis 8023 (100 parts) was added and stirring was continued. This mixture, designated Size A gave a product containing rosin (active ingredient) and AKD (active ingredient) 2 parts of rosin and 1 part of AKD, on a dry basis. Size A and Hi-pHase 35J were used to size a paper furnish consisting of UBK 30 parts and waste test liner 70 parts. Paper making was conducted at 40 and 60° C. The sizing efficiency results (HST seconds) are given in Table 2. The results show that the rosin size (Hi-phase 35J) loses efficiency at the higher temperature, whereas Size A gives superior sizing at both temperatures. The results also show that Size A was not significantly affected as the temperature was increased from 40 to 60° C.

TABLE 2

| Size addition | HST sizing (seconds) paper made at 40 & 60° C. | | | |
|---|---|---|---|---|
| level % dry | Hi-pHase 35J | | Size A | |
| basis (db) | 40° C. | 60° C. | 40° C. | 60° C. |
| 0.4 | 50 | 77 | 293 | 366 |
| 0.7 | 197 | 163 | 456 | 467 |
| 1.0 | 305 | 236 | 530 | 589 |

### Example 3

Two sizes. Ultraphase available from Hercules Inc. Wilmington, Del., USA and Precis 8023, from Hercules UK, 31 London Rd,. Reigate, Surrey, UK, RH2 9YA were blended together, as follows. Ultraphase (149.35 parts) was charged to a vessel and stirred with a paddle stirrer, Precis 8023 (100 parts) was added and stirring was continued. This mixture, designated Size B gave a product containing rosin (active ingredient) and AKD (active ingredient) in the ratio 2 parts of rosin and 1 part of AKD, on a dry basis. Size B and Ultraphase were used to size a paper furnish consisting of UBK 30 parts and waste test liner 70 parts. Paper making was conducted at 40 and 60° C. The sizing efficiency results (HST seconds) are given in Table 3. The results show the improved performance of Size B in comparison with the rosin size and also show that the exemplified size is less affected by the increase in temperature of 20 degrees.

TABLE 3

| Size addition | HST sizing (seconds), paper made at 40 & 60° C. | | | |
|---|---|---|---|---|
| level % dry | Ultraphase | | Size B | |
| basis (db) | 40° C. | 60° C. | 40° C. | 60° C. |
| 0.7 | 177 | 139 | 428 | 423 |
| 1.0 | 315 | 264 | 481 | 648 |

### Example 4

Sizes A, B (as described above), together with C and D were prepared from the following sizes, Ultraphase available from Hercules Inc. Wilmington, Del., USA, Precis 8023 and Hi-pHase 35J both available from Hercules UK, 31 London Rd, Reigate, Surrey, UK, RH2 9YA. The composition of these sizes are given in Table 4 as parts by weight of as received material. These mixtures, gave products containing rosin (active ingredient) and AKD (active ingredient), in the ratios 2 or 3 parts of rosin and 1 part of AKD, on a dry basis, as shown in the Table 4.

TABLE 4

| Size in the | Size A (2 | Size B (2 | Size C (3 | Size D (3 |
|---|---|---|---|---|
| blend | parts rosin) | parts rosin) | parts rosin) | parts rosin) |
| Precis 8023 | 100 | 100 | 100 | 100 |
| Ultraphase | | 149.35 | 224 | |
| Hi-pHase 35J | 150.65 | | | 226 |

The sizes were blended together, as follows. Ultraphase or Hi-pHase 35J were charged to a vessel and stirred with a paddle stirrer, Precis 8023 was added and stirring was continued. The blended mixtures were used to size a paper furnish consisting of UBK 30 parts and waste test liner 70 parts. Paper making was conducted at 40 and 60° C. The sizing efficiency of Sizes A, B, C and D were compared with the efficiency of Hi-pHase 35J and Precis 8023. The results (Cobb gm/sq.m./60 sec) are given in Table 5. The results show the improved performance of the sizes A, B, C and D in comparison with the rosin and AKD sizes and also show that the sizes are less affected by the increase in temperature of 20 degrees. The synergy developed by the combination of sizing materials was seen in the results of this trial. At an addition level 0.2% db, sizes A and B contain 0.058 parts active AKD and 0.116 parts active rosin sizing material. Also at 0.2 % db sizes C and D contain 0.044 parts active size and 0.132 parts active rosin sizing material. Performance levels for the exemplified sizes are significantly better than individual sizes used separately. At an addition rate of 0.13% and below Precis 8023 does not create a sized sheet of paper.

TABLE 5

| | Cobb sizing (gm/sq · m./60 seconds), paper made at 40 & 60° C. | | | | | | | | | | | |
|---|---|---|---|---|---|---|---|---|---|---|---|---|
| | Precis 8023 | | Hi-pHase 35J | | Size A | | Size B | | Size C | | Size D | |
| Size % db | 40 | 60 | 40 | 60 | 40 | 60 | 40 | 60 | 40 | 60 | 40 | 60 |
| 0.07 | unsized | unsized | | | | | | | | | | |
| 0.13 | unsized | unsized | | | | | | | | | | |
| 0.2 | | | 55 | 54 | 30 | 39.5 | 27 | 42 | 35 | 49 | 28.5 | 47 |
| 0.23 | 24.5 | 23.7 | | | | | | | | | | |
| 0.4 | | | 23 | 29 | 18.4 | 20.6 | 19.4 | 20 | 19.5 | 21.8 | 17.7 | 21.1 |
| 0.7 | | | 22 | 20.5 | 17.1 | 17.3 | 16.7 | 16.9 | 15 | 17.5 | 14.3 | 18.2 |

### Example 5

A sizing efficiency comparison at a paper making temperature of 70° C. and 60° C. was done with Hi-pHase 35J, Ultraphase and Size A, as used in the previous Examples. The results of this Example showed that Size A was more efficient than either of the rosin sizes used alone, in the medium to hard sized range of 20 to 25 Cobb (see Table 6) and range 100-500 seconds HST (see Table 7).

TABLE 6

| | Cobb sizing (gm/sq.m./60 seconds), paper | | | | | |
|---|---|---|---|---|---|---|
| | made at 60 & 70° C. | | | | | |
| | Hi-pHase 35J | | Ultraphase | | Size A | |
| Size % db | 60 | 70 | 60 | 70 | 60 | 70 |
| 0.45 | 38.4 | 30.6 | 26.7 | 30.8 | 25.8 | 25.4 |
| 0.6 | 27.6 | 29.6 | 25.4 | 25.4 | 22.4 | 22.4 |
| 0.8 | 21.7 | 22.3 | 20.7 | 24.4 | 19.6 | 19.9 |

TABLE 7

| | HST sizing (seconds), paper | | | | | |
|---|---|---|---|---|---|---|
| | made at 60 & 70° C. | | | | | |
| | Hi-pHase 35J | | Ultraphase | | Size A | |
| Size % db | 60 | 70 | 60 | 70 | 60 | 70 |
| 0.45 | 67 | 226 | 563 | 199 | 976 | 816 |
| 0.6 | 412 | 227 | 681 | 248 | 1620 | 1277 |
| 0.8 | 805 | 1217 | 1401 | 748 | 1664 | 2450 |

From the foregoing description, one skilled in the art can easily ascertain the essential characteristics of this invention, and without departing from the spirit and scope thereof, can make various changes and modifications of the invention to adapt it to various usages and conditions.

What is claimed is:

1. A method of processing pulp with a sizing agent, comprising:
adding to a cellulosic pulp, in a wet part of a paper making process, a sizing mixture of (a) rosin material and (b) an AKD sizing agent; and
at least a portion of the wet part of the paper making process is at a temperature of at least about 40° C.

2. The method of claim 1, wherein the AKD sizing agent comprises a member selected from the group consisting of alkyl ketene dimers, alkenvl ketene dimers, and multimers and mixtures thereof.

3. The method of claim 2, wherein the AKD sizing agent comprises an alkyl ketene dimer.

4. The method of claim 2, wherein the AKD sizing agent comprises an alkenyl ketene dimer.

5. The method of claim 2, wherein the AKD sizing agent comprises a multimer.

6. The method of claim 1, wherein the AKD sizing agent comprises a member selected from the group consisting of ketene dimers, ketene multimers and mixtures thereof.

7. The method of claim 1, wherein substantially all of the wet part of the paper making process is at a temperature of at least about 40° C.

8. The method of claim 1, wherein at least a portion of the paper making process is at a temperature of at least about 45° C.

9. The method of claim 8, wherein substantially all of the wet part of the paper making process is at a temperature of at least about 45° C.

10. The method of claim 1, wherein at least a portion of the paper making process is at a temperature of at least about 50° C.

11. The method of claim 10, wherein substantially all of the wet part of the paper making process is at a temperature of at least about 50° C.

12. The method of claim 1, wherein at least a portion of the paper making process is at a temperature of at least about 55° C.

13. The method of claim 12. wherein substantially all of the wet part of the paper making process is at a temperature of at least about 55° C.

14. The method of claim 13. wherein at least a portion of the paper making process is at a temperature of at least about 60° C.

15. The method of claim 14, wherein substantially all of the wet part of the paper making process is at a temperature of at least about 60° C.

16. The method of claim 1, wherein at least a portion of the paper making process is at a temperature of at least about 65° C.

17. The method of claim 16, wherein substantially all of the wet part of the paper making process is at a temperature of at least about 65° C.

18. The method of claim 1, wherein at least a portion of the paper making process is at a temperature of at least about 70° C.

19. The method of claim 18, wherein substantially all of the wet part of the paper making process is at a temperature of at least about 70° C.

20. The method of claim 1, wherein the sizing mixture paper comprises (c) alum.

21. The method of claim 20, wherein substantially all of the wet part of the paper making process is at a temperature of at least about 40° C.

22. The method of claim 20, wherein at least a portion of the paper making process is at a temperature of at least about 45° C.

23. The method of claim 22, wherein substantially all of the wet part of the paper making process is at a temperature of at least about 45° C.

24. The method of claim 20, wherein at least a portion of the paper making process is at a temperature of at least about 50° C.

25. The method of claim 24, wherein substantially all of the wet part of the paper making process is at a temperature of at least about 50° C.

26. The method of claim 20, wherein at least a portion of the paper making process is at a temperature of at least about 55° C.

27. The method of claim 26, wherein substantially all of the wet part of the paper making process is at a temperature of at least about 55° C.

28. The method of claim 20, wherein at least a portion of the paper making process is at a temperature of at least about 60° C.

29. The method of claim 28, wherein substantially all of the wet part of the paper making process is at a temperature of at least about 60° C.

30. The method of claim 20, wherein at least a portion of the paper making process is at a temperature of at least about 65° C.

31. The method of claim 30, wherein substantially all of the wet part of the paper making process is at a temperature of at least about 65° C.

32. The method of claim 20, wherein at least a portion of the paper making process is at a temperature of at least about 70° C.

33. The method of claim 32, wherein substantially all of the wet part of the paper making process is at a temperature of at least about 70° C.

34. A method of processing pulp with a sizing agent, comprising:
adding to a cellulosic pulp, in a wet part of a paper making process, a sizing mixture of (a) rosin material and (b) an AKD sizing agent, the AKD sizing agent comprising at least one compound selected from compounds of the formula: 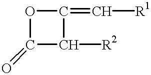
wherein R¹ and R², which can be the same or different, are organic hydrophobic groups, selected from saturated or unsaturated hydrocarbon, straight or branched chain alkyl having at least 6 C atoms, cycloalkyl having at least 6 carbon atoms. aryl, aralkyl and alkaryl, and/or a compound of the formula: 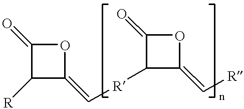
wherein
n is an integer of from 1, to about 20;
R and R″ are the same or different and are an organic hydrophobic group having at least 6 C atoms, independently selected from the group of straight (linear) or branched alkyl or straight (linear) or branched alkenyl; and
R′ is a branched or straight chain, or alicyclic, of from about 1 to about 40 carbon atoms. and mixtures of compounds of the foregoing compounds, wherein at least a portion of the wet part of the paper making process is at a temperature of at least about 40° C.

35. The method of claim 34, wherein substantially all of the wet part of the paper making process is at a temperature of at least about 40° C.

36. The method of claim 34, wherein at least a portion of the paper making process is at a temperature of at least about 45° C.

37. The method of claim 36, wherein substantially all of the wet part of the paper making process is at a temperature of at least about 45° C.

38. The method of claim 34, wherein at least a portion of the paper making process is at a temperature of at least about 50° C.

39. The method of claim 38, wherein substantially all of the wet part of the paper making process is at a temperature of at least about 50° C.

40. The method of claim 34, wherein at least a portion of the paper making process is at a temperature of at least about 55° C.

41. The method of claim 40, wherein substantially all of the wet part of the paper making process is at a temperature of at least about 55° C.

42. The method of claim 41, wherein at least a portion of the paper making process is at a temperature of at least about 60° C.

43. The method of claim 42, wherein substantially all of the wet part of the paper making process is at a temperature of at least about 60° C.

44. The method of claim 34 wherein at least a portion of the paper making process is at a temperature of at least about 65° C.

45. The method of claim 44, wherein substantially all of the wet part of the paper making process is at a temperature of at least about 65° C.

46. The method of claim 45, wherein at least a portion of the paper making process is at a temperature of at least about 70° C.

47. The method of claim 46, wherein substantially all of the wet part of the paper making process is at a temperature of at least about 70° C.

48. The method of claim 34, wherein the sizing mixture further comprises © alum.

49. The method of claim 48, wherein substantially all of the wet part of the paper making process is at a temperature of at least about 40° C.

50. The method of claim 48, wherein at least a portion of the paper making process is at a temperature of at least about 45° C.

51. The method of claim 50, wherein substantially all of the wet part of the paper making process is at a temperature of at least about 45° C.

52. The method of claim 48, wherein at least a portion of the paper making process is at a temperature of at least about 50° C.

53. The method of claim 52, wherein substantially all of the wet part of the paper making process is at a temperature of at least about 50° C.

54. The method of claim 48, wherein at least a portion of the paper making process is at a temperature of at least about 55° C.

55. The method of claim 54, wherein substantially all of the wet part of the paper making process is at a temperature of at least about 55° C.

56. The method of claim 48, wherein at least a portion of the paper making process is at a temperature of at least about 60° C.

57. The method of claim 56, wherein substantially all of the wet part of the paper making process is at a temperature of at least about 60° C.

58. The method of claim 48, wherein at least a portion of the paper making process is at a temperature of at least about 65° C.

59. The method of claim 58, wherein substantially all of the wet part of the paper making process is at a temperature of at least about 65° C.

60. The method of claim 48, wherein at least a portion of the paper making process is at a temperature of at least about 70° C.

61. The method of claim 60, wherein substantially all of the wet part of the paper making process is at a temperature of at least about 70° C.

62. The method of claim 34, wherein R¹ and R² is each independently selected from the group consisting of alkyl and alkenyl, straight chain or branched hydrocarbon groups of from 12 to 30 C atoms, and mixtures thereof.

63. The method of claim 34, wherein R¹ and R² is each independently selected from the group consisting of alkyl and alkenyl, straight chain or branched hydrocarbon groups of from 16 to 22 C atoms, and mixtures thereof.

64. The method of claim 34, wherein R¹ and R² is each independently selected from the group consisting of alkyl and alkenyl, straight chain or branched hydrocarbon groups of from 1 to 18 C atoms, and mixtures thereof.

65. The method of claim 34, wherein n is an integer of from about 1 to about 8.

66. The method of claim 34, wherein n is an integer of from about 1 to about 6.

67. The method of claim 34, wherein n is an integer of from about about 2 to about 5.

68. The method of claim 34, wherein R and R″ are about C 10-C 20.

69. The method of claim 34, wherein R and R″ are about C 14-C 16.

70. The method of claim 34, wherein R′ is selected from about C 2- C 12, from about C 4-C 8; C 28-C 32; and mixtures thereof.

71. The method of claim 2, wherein the AKD sizing agent comprises a ketene dimer.
